(19) United States
(12) Patent Application Publication
(10) Pub. No.: US 2026/0017048 A1
(43) Pub. Date: Jan. 15, 2026

(54) MACHINE LEARNING ASSET MANAGEMENT

(71) Applicant: HUAWEI TECHNOLOGIES CO., LTD., Shenzhen (CN)

(72) Inventors: Filipe Roseiro COGO, Kingston (CA); Dayi LIN, Toronto (CA); Jia-Huei LIN, Kingston (CA); Gallaba Mudiyanselage Keheliya Bandara GALLABA, Kingston (CA); Gopi Krishnan RAJBAHADUR, Kingston (CA); Ahmed E. HASSAN, Kingston (CA)

(21) Appl. No.: 18/772,649

(22) Filed: Jul. 15, 2024

(51) Int. Cl. G06F 8/71

(52) U.S. Cl. CPC G06F 8/71

(57) ABSTRACT

A computer implementable method, an asset developer computer, and a computer readable medium for managing an asset for machine learning are provided. The method comprises retrieving, from a version control system server over a network, an asset for machine learning, deserializing the asset from a serialized asset data format to a deserialized asset data format using a seriazlier/deserializer to generate a deserialized asset, modifying, via at least one processor of an asset developer workstation, the deserialized asset to generate a new version of the asset, serializing the new version of the asset using the serializer/deserializer to generate a serialized new asset, and sending, from the asset developer workstation, the serialized new asset to the version control system server over the network for storage.

### FIELD

The present technology relates to machine learning asset management, particular to systems and methods for managing machine learning assets in conjunction with a version control system.

### BACKGROUND

Asset management in the context of foundation model software (FMware) involves the strategic oversight and organization of resources essential for the development, deployment, and maintenance of foundation model systems. Developing FMware includes managing a variety of assets that extend beyond traditional software development. These assets include not only the foundation models themselves but also resources such as datasets, prompts, and agents. Consequently, specialized management methods for the assets may be provided. Traditional asset management systems do not support a tailored approach to asset management.

Some traditional software engineering techniques, like version control systems (VCS), address some asset management challenges, but they are not designed to handle FMware-specific constraints or formats. Therefore, explicit management tools and methodologies are provided to systematically manage assets throughout the entire lifecycle of FMware development.

At the core of FMware asset management are the foundation models themselves, which are large-scale neural network architectures trained on vast datasets to understand human language and context. Managing these models is complex due to their size, which exceeds the capabilities of traditional version control systems like Git. Additionally, these models frequently change due to fine-tuning for various tasks, requiring versioning and tracking of every checkpoint. Associated metadata and hyperparameters also need to be versioned and traced back to specific experimental runs.

FMware involves assets composed of sub-components, necessitating a granular approach to manage these components and their relationships. For example, a prompt asset comprises multiple sub-components such as persona, examples, and instructions, each requiring individual management while maintaining their association with the corresponding prompt. Agents, another FMware asset, are dynamic and autonomous, generating numerous versions during execution, thus needing a scalable management approach.

Versioning supports tracking asset evolution within the FMware workflow. Some traditional VCSs are adept at managing small, text-based code files but are less effective for large datasets, models, prompts, and agents. Some versioning strategies in FMware involve storing versioned assets by keeping copies of each modified version, storing deltas for space efficiency, or versioning pipeline metadata to reproduce assets. Assets can be stored internally or externally relative to the management tools. Internally stored assets are managed by the user, while externally stored assets are tracked via identifier pointers, suitable for large files and accessible from cloud-hosted services like notebooks and cloud infrastructure.

FMware asset management may require domain-specific operations tailored to the unique abstraction levels of FM assets. This may require a method flexible enough to adapt to the specific needs associated with different assets.

It is desirable to provide systems and methods to allow asset developers to describe how assets and their sub-components should be represented and stored, while leveraging the features of an underlying VCS, such as tracking, branching, diffing, patching, etc. to support asset versioning and collaborative development. It is further desirable to allow developers to write customized logic that combines version control operations (e.g., branching) with asset representation and storage. Furthermore, other desirable features and characteristics of the present disclosure will become apparent from the subsequent detailed description and the appended claims, taken in conjunction with the accompanying drawings and the foregoing technical field and background.

### SUMMARY

The present disclosure provides methods, systems and devices for overcoming at least some drawbacks present in prior art solutions and attaining the objects set out above.

In at least one aspect of the present technology, there is provided a computer implementable method of managing an asset for machine learning. The method comprises retrieving, from a version control system server over a network, an asset for machine learning, deserializing the asset from a serialized asset data format to a deserialized asset data format using a seriazlier/deserializer to generate a deserialized asset, modifying, via at least one processor of an asset developer workstation, the deserialized asset to generate a new version of the asset, serializing the new version of the asset using the serializer/deserializer to generate a serialized new asset, and sending, from the asset developer workstation, the serialized new asset to the version control system server over the network for storage.

In some embodiments of the method, the serializer/deserializer is stored in a central repository accessible by a plurality of asset developer workstations.

In some embodiments of the method, the asset comprises at least one of: machine learning models, datasets, configuration files, source code, prompts, and software agents.

In some embodiments of the method, the method further comprises, via the at least one processor of the developer workstation, a commit request to the version control system to initiate storing of the serialized new asset, the commit request including: serialized asset data corresponding to the serialized new asset and at least one of: asset name, asset version number, metadata comprising model name, storage location and/or timestamp, dependencies, and hash value for verification.

In some embodiments of the method, the method further comprises generating, via the at least one processor of the developer workstation, a hash value using a cryptographic hash function based on the new version of the asset and sending, from the asset developer workstation, the serialized new asset and the hash value to the version control system server over the network for storage.

In some embodiments of the method, the deserialized asset data and serialized asset data corresponding to the serialized new asset comprises: for a machine learning model, binary deserialized asset data representing the weights and architecture of the machine learning model and serialized asset data in the form of JSON string or binary blob; for datasets, CSV, Parquet, or database tables deserialized asset data and JSON string or binary blob for serialized asset data; for configuration files, the deserialized asset data includes text files and the serialized asset data includes JSON string representing the configuration parameters; for prompts, the deserialized asset data includes text files or strings containing prompts and the serialized asset data includes JSON string containing prompt text and related metadata; and for software agents, the deserialized asset data includes executable code or scripts and the serialized asset data includes JSON string or binary blob.

In some embodiments of the method, the method further comprises initializing, via the at least one processor of the asset developer workstation, an asset by creating an asset class and populating the asset class with asset data retrieved external storage over the network.

In some embodiments of the method, the method further comprises sending a fetch request, via the at least one processor and from the developer workstation, the fetch request including the asset name and version tag; retrieving, from the version control system server over the network, an asset corresponding to the fetch request, wherein the asset is in serialized data format; and deserializing the asset using the serializer/deserializer for modification on the developer workstation.

In some embodiments of the method, the version control system retrieves serialized asset data based on the asset name and the version tag and associated metadata including a hash vale and wherein the version control system generates a reference hash value based on the serialized asset data, the version control system comparing the hash value and the reference hash value to verify that a correct version of the serialized asset data has been retrieved before sending to the asset developer workstation over the network.

In some embodiments of the method, an asset developer of the developer workstation defines, through a user interface, custom serialization and deserialization logic for each of a plurality of asset types, the serialization and deserialization logic used by the serializer/deserializer, the serialization and deserialization logic including instructions for converting the asset between serialized and deserialized data formats, wherein the serialization and deserialization logic differs based on asset type.

In some embodiments of the method, the method further comprises storing the custom serialization and deserialization logic in a repository accessible to a plurality of developer workstations.

In some embodiments of the method, the method further comprises determining a storage location of the serialized new asset based on asset size, wherein the storage location includes local storage of the version control system and external cloud storage.

In at least one aspect of the present technology, there is provided an asset developer computer for managing an asset for machine learning, comprising: at least one processor; local storage comprising a non-transitory computer-readable medium storing instructions that, when executed by the at least one processor, are configured to: retrieve, from a version control system server over a network, an asset for machine learning; deserialize the asset from a serialized asset data format to a deserialized asset data format using a seriazlier/deserializer to generate a deserialized asset; modify the deserialized asset to generate a new version of the asset; serialize the new version of the asset using the serializer/deserializer to generate a serialized new asset; and send the serialized new asset to the version control system server over the network for storage.

In some embodiments of the computer, the asset comprises at least one of: machine learning models, datasets, configuration files, source code, prompts, and software agents.

In some embodiments of the computer, the instructions, when executed by the at least one processor, are configured to send a commit request to the version control system to initiate storing of the serialized new asset, the commit request including: serialized asset data corresponding to the serialized new asset and at least one of: asset name, asset version number, metadata comprising model name, storage location and/or timestamp, dependencies, and hash value for verification.

In some embodiments of the computer, the instructions, when executed by the at least one processor, are configured to: generate a hash value using a cryptographic hash function based on the new version of the asset and send the serialized new asset and the hash value to the version control system server over the network for storage.

In some embodiments of the computer, the instructions, when executed by the at least one processor, are configured to: send a fetch request, the fetch request including an asset name and a version tag, retrieve, from the version control system server over the network, an asset corresponding to the fetch request, wherein the asset is in serialized data format, and deserialize the asset using the serializer/deserializer for modification on the developer workstation.

In some embodiments of the computer, an asset developer operating the asset developer computer defines, through a user interface, custom serialization and deserialization logic for each of a plurality of asset types, the serialization and deserialization logic used by the serializer/deserializer, the serialization and deserialization logic including instructions for converting the asset between a serialized and deserialized data format, wherein the serialization and deserialization logic differs based on asset type.

In some embodiments of the computer, the deserialized asset is stored on the local memory.

In at least one aspect of the present technology, there is provided a computer readable medium storing instructions that, when executed by at least one processor are configured to perform any of the methods described herein. In some embodiments, the at least one process is configured to perform a method for managing an asset for machine learning, the method comprising: retrieving, from a version control system server over a network, an asset for machine learning; deserializing the asset from a serialized asset data format to a deserialized asset data format using a seriazlier/deserializer to generate a deserialized asset; modifying, via at least one processor of an asset developer workstation, the deserialized asset to generate a new version of the asset; serializing the new version of the asset using the serializer/deserializer to generate a serialized new asset; and sending, from the asset developer workstation, the serialized new asset to the version control system server over the network for storage.

In another aspect, embodiments of this disclosure provide a computer readable storage medium, comprising one or more instructions, wherein when the one or more instructions are run on a computer, the computer performs any of the methods disclosed herein.

In another aspect, embodiments of this disclosure provide a non-transitory computer-readable medium storing instruction the instructions causing a processor in a device to implement any of the methods disclosed herein.

In another aspect, embodiments of this disclosure provide a device configured to perform any of the methods disclosed herein.

In another aspect, embodiments of this disclosure provide a processor, configured to execute instructions to cause a device to perform any of the methods disclosed herein.

In another aspect, embodiments of this disclosure provide an integrated circuit configure to perform any of the methods disclosed herein.

According to one aspect of this disclosure, there is provided a module comprising: one or more circuits for performing any of the methods disclosed herein.

According to one aspect of this disclosure, there is provided an apparatus comprising: one or more processors functionally connected to one or more memories for performing any of the methods disclosed herein.

According to one aspect of this disclosure, there is provided an apparatus configured to perform any of the methods disclosed herein.

In some embodiments the apparatus comprises one or more units configured to perform the above-described method.

According to one aspect of this disclosure, there is provided one or more non-transitory, computer-readable storage media comprising computer-executable instructions, wherein the instructions, when executed, cause at least one processing unit, at least one processor, or at least one circuits to perform any of the methods disclosed herein.

According to one aspect of this disclosure, there is provided one or more computer-readable storage media storing a computer program, wherein, when the computer program is executed by an apparatus, the apparatus is enabled to implement any of the methods disclosed herein.

According to one aspect of this disclosure, there is provided a computer program product including one or more instructions, wherein, when the instructions are executed by an apparatus, the apparatus is enabled to implement any of the methods disclosed herein.

According to one aspect of this disclosure, there is provided a computer program, wherein, when the computer program is executed by a computer, an apparatus is enabled to implement any of the methods disclosed herein.

According to one aspect of this disclosure, there is provided a system comprising a node for performing any of the methods disclosed herein.

In the context of the present specification, a “server” is a computer program that is running on appropriate hardware and is capable of receiving requests (e.g., from devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “device” is any computer hardware that is capable of running software appropriate to the relevant task at hand. Thus, some (non-limiting) examples of devices include personal computers (desktops, laptops, netbooks, etc.), smartphones, and tablets, as well as network equipment such as routers, switches, and gateways. It should be noted that a device acting as a device in the present context is not precluded from acting as a server to other devices. The use of the expression “a device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers. It can be said that a database is a logically ordered collection of structured data kept electronically in a computer system

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 illustrates an asset management system according to an exemplary embodiment;

FIG. 2 illustrates the asset management system of FIG. 1 in further detail according to an exemplary embodiment; and

FIGS. 3A and 3B illustrate a method for asset management according to an exemplary embodiment.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

As used herein, a foundation model is a machine learning model trained on a large-scale and generalist dataset, which can be adapted to perform a wide range of specialized downstream tasks.

As used herein, Foundation Model Applications (FMware) refers to software applications that use foundation models as one of their building blocks, such as ChatGPT. Examples of foundation models include BERT, Grok etc.

As used herein, a Software Engineering (SE) Asset is a software artifact resulting from the inception, development, maintenance, evolution, or delivery of a software product, possessing intrinsic value that justifies its management.

As used herein, an FMware Asset involves a series of assets in addition to traditional SE assets, including models (often in large binary format), performance metrics, configurations (such as hyper-parameters and metadata), datasets, prompts, workflows, and agents.

As used herein, asset management in software engineering refers to the set of practices related to the creation and maintenance of SE assets, ensuring that as a software project scales, assets can be versioned, tracked, quality controlled, and shared.

As used herein, a version control system is a software application that tracks and manages changes in software engineering assets.

With these fundamentals in place, the present disclosure provides some non-limiting examples to illustrate various implementations of aspects of the present technology.

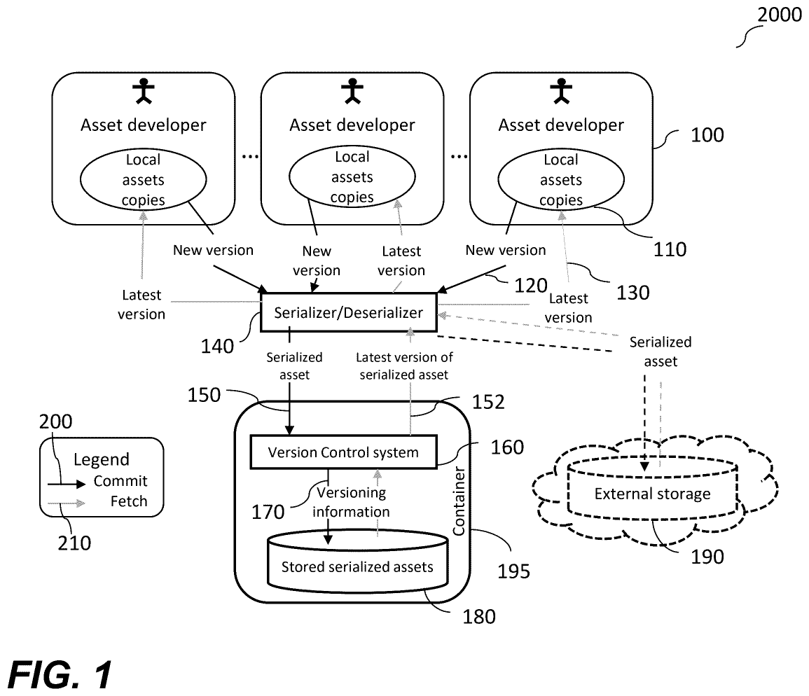

FIG. 1 illustrates an exemplary asset management system 2000, which includes components and data flows for managing foundation model assets. The system features asset developers 100 who create and manage local assets copies 110. The asset developers 100 generate new versions 120, which are serialized by the serializer/deserializer 140 into serialized assets 150.

The latest versions 130 are fetched by the asset developers 100 and managed by the version control system 160, which stores versioning information 170 and the serialized assets 150 in stored serialized assets 180. The system 2000 also integrates external storage 190 for large assets. The commit process 200 and the fetch process 210 facilitates the version control and retrieval of these assets.

The asset management system 2000 enables asset developers 100 to define how assets and their sub-components are represented and stored. This is, in embodiments, achieved by leveraging the capabilities of the version control system 160, such as tracking, branching, diffing, and patching, to support asset versioning and collaborative development.

The technology described herein allows structuring of FMware assets combined with the serializer/deserializer 140, which facilitates customized logic for version control operations integrated with asset representation and storage.

The serializer/deserializer 140 supports customization of asset storage based on the asset format. For example, large binaries can be stored in external storage 190 while associated metadata is stored within the version control system 160.

Additionally, the serializer/deserializer 140 encodes/decodes dependencies between assets. For instance, a JSON object can store a dependency between the model and the prompt.

These functionalities ensure that all FMware assets are efficiently managed, stored, and versioned, facilitating seamless collaborative development.

In FIG. 1, there is shown local asset management whereby asset developers work on local asset copies 110, creating new versions 120 or fetching the latest versions 130 for modifications. A custom serializer/deserializer 140 allows the asset developers 100 to define custom serialization and deserialization logic for each asset type, managed by the serializer/deserializer 140, ensuring flexibility and extensibility as new asset types are integrated. Version control operations are facilitated in which new asset versions 120 are committed 200, and the latest versions are pulled 210 using a version control system 160. The version control system system may pull the latest asset versions from stored serialized assets 180 and/or from external storage 190, managing versioning information 170 and ensuring the correct version of the assets is fetched. The asset management system 2000 of FIG. 1 ensures efficient versioning, storage, and retrieval of various FMware assets, facilitating seamless collaborative development and robust asset management.

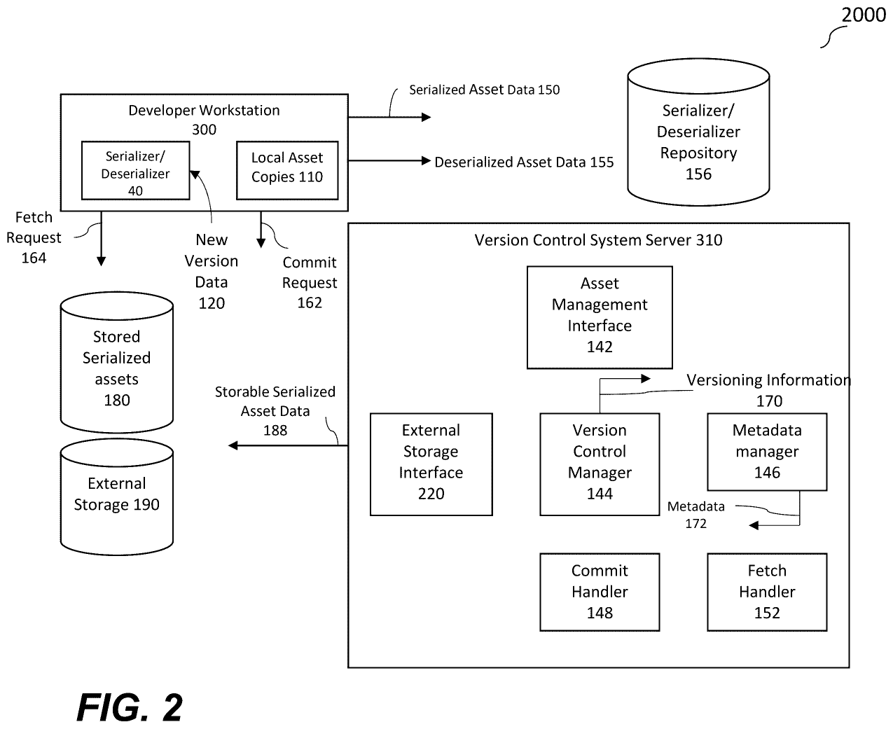

Continuing to refer to the exemplary embodiment of FIG. 1, the asset developers 100 are responsible for creating and managing local asset copies 110. Each developer works on their own set of assets, which they can modify and update as needed. The asset developers 100 operate on a developer workstation 300 (as shown in FIG. 2) that store local asset copies 110. The local asset copies 110 are the individual versions of the assets that developers work on locally. Each developer maintains a local asset copy 110 that can be edited and updated before being committed to the version control system 160.

Local asset copies 110 may refer to the versions of assets that are maintained and modified by asset developers on their individual developer workstations 300. These local asset copies 110 represent the working versions of the assets that developers interact with directly, making necessary changes and updates before these assets are serialized and committed to the version control system for tracking and collaboration.

Local asset copies 110 can vary widely based on the type of asset being managed within the FMware context. The local asset copies 110 can include one or any combination of the following possibilities.

The local asset copies 110 can include model files. Model files can include pre-trained models, which may be in the form of large binary files containing the weights and architecture of pre-trained foundation models. The models may include Natural Language Processing (NLP) models such as transformer models (e.g., BERT, GPT, T5), sequence-to-sequence models, language models (e.g., n-gram, RNN), and embedding models (e.g., Word2Vec, GloVe). Additionally, multimodal models like CLIP and DALL-E, specialized models for speech recognition and synthesis, dialog systems, and fine-tuned models for specific domains and tasks may also be managed by the asset management system 2000. Fine-tuned models include versions of pre-trained models that have been fine-tuned on specific datasets for specialized tasks. The local asset copies 110 may include raw data, specifically unprocessed data collected from various sources, such as text, images, or other forms of input data.

The local asset copies 110 can include processed training data that has been cleaned, pre-processed, and formatted for training and evaluation.

The local asset copies 110 can include prompts, in particular developer prompts. The prompts include static prompts, which may be fixed text or input sequences designed to elicit specific responses from the model. The prompts can include dynamic prompts including templates or scripts that generate prompts based on certain parameters or user inputs.

The local asset copies 110 can include configuration files, which may include hyperparameter settings such as JSON or YAML files containing hyperparameter configurations for training or fine-tuning models. The local asset copies 110 can include experiment settings that store configurations for different experimental setups, including training schedules, data splits, and evaluation metrics.

The local asset copies 110 can include source code including training scripts used to train models. The source code can include evaluation scripts used to evaluate model performance on various benchmarks. The source code can include utility scripts for data processing, visualization, and/or other auxiliary tasks.

The local asset copies 110 can include metadata including model metadata such as information about model versions, training datasets, hyperparameters, and performance metrics. The metadata can include data metadata including details about datasets, including source, format, preprocessing steps, and usage constraints.

The local asset copies 110 can include README files including text or markdown files describing the project, setup instructions, and usage guidelines and change logs including documentation tracking changes made to the asset over time, including updates, bug fixes, and improvements.

The asset developers 100 may create and modify local asset copies 110 on their developer workstations 300. The changes may be made to the local asset copies 110 based on the current requirements of a project. Once changes are finalized, the local asset copies 110 are serialized using developer-specified serialization logic of the serializer/deserializer 140. The serialized data, along with metadata, is committed to the version control system 160 in the form of the serialized asset 150. When needed, the latest version of a serialized asset 152 are fetched from the version control system 160. The serialized data is deserialized by the serlializer/deserializer 140 back into its original format for further use or modification by the asset developer(s) 100.

When developers create new versions 120 of their assets, these new versions 120 are serialized and prepared for storage. This involves converting the assets into a format suitable for version control and storage. The serializer/deserializer 140 can be customized by the asset developer 100 and shared among developer work stations 300 so that each of the asset developers 100 in a given team may access the serializer/deserializer 140 from a central server.

The latest version 130 of an asset is the most recent serialized version stored in the version control system 160. Asset developers 100 can fetch this latest version to ensure they are working with the most up-to-date information.

The serializer/deserializer 140 is configured to convert assets into a serialized format for storage by the version control system 160 and deserializing assets retrieved via the version control system 160 back into their original format for use by the asset developers 100. The asset developers 100 may specify the serialization/deserialization logic, ensuring that each asset type is handled appropriately.

Asset developers 100 can customize the serialization/deserialization logic of the serializer/deserializer 140 in a variety of ways to ensure that each type of asset is handled appropriately. Such customization supports adapting the management process to the specific requirements and characteristics of various assets used in FMware. Exemplary customization options are described in the following.

In some embodiments, the asset developer 100 can customize a format specification including how different types of assets are converted into a serialized format. This can involve specifying the data structure (e.g., JSON, XML, binary) and the schema that should be used to store the asset data.

In some embodiments, the custom logic can include methods for compressing large assets before serialization to save storage space and improve transfer efficiency.

In some embodiments, the custom logic can include encryption methods by which asset developers 100 can implement encryption within the serialization process to protect sensitive data during storage and transmission.

The custom logic can specify what metadata should be included during serialization. This might include version numbers, timestamps, author information, and dependency information. In exemplary embodiments, the metadata includes an asset identifier, which may be a unique identifier for the asset, such as the model name. The metadata may include storage location about where the asset is stored, such as a URL or path in cloud storage (external storage 190) or in the stored serialized assets 180. The metadata may include the date and time when the asset was serialized or modified. The metadata may include details about the asset version, which could include a version number or a hash value (SHA) for integrity and version tracking. The metadata may include dependency information which includes data about dependencies between different assets, ensuring that all necessary components can be retrieved and used together.

The serializer/deserializer 140 may similarly include custom deserialization logic, which is a counterpart to the serialization logic, ensuring that serialized assets are accurately reconstructed for use. Custom deserialization logic may include format parsing defining how to parse the serialized data back into its original format, interpreting the specific data structure and schema used during serialization. The deserialization logic may include decompression techniques applying corresponding decompression methods to restore the original asset data if compression was used during serialization. The deserialization logic may include decryption methods implementing decryption processes to ensure that encrypted data is properly decrypted and accessible. The deserialization logic may include dependency resolution for resolving dependencies between assets, ensuring that all required components are retrieved and correctly linked.

Asset developers 100 can customize the serialization/deserialization logic of the serializer/deserializer 140 in various ways as described above to ensure that each type of asset is appropriately managed. This includes defining custom methods for formatting, compressing, encrypting, and including metadata during serialization, as well as parsing, decompressing, decrypting, and resolving dependencies during deserialization. This flexibility allows developers to tailor the asset management process performed by the asset management system 2000 to the specific requirements of different asset types used in FMware.

The serializer/deserializer 140 may be stored in a central repository (see the serializer/deserializer repository 156 shown in FIG. 2) as part of a shared library or module. This serializer/deserializer repository 156 is accessible by all asset developers 110. The central repository may be a version-controlled storage system, typically hosted on a server with persistent memory, such as a solid-state drive (SSD) or hard disk drive (HDD). The central serializer/deserializer repository 156 stores the shared code base, including the serialization/deserialization logic, and facilitates consistent access and updates by asset developers 100.

The asset developers 100 can include the shared library in their local development environment by importing it, ensuring consistency across different developer workstations 300.

In some embodiments, the shared library is maintained in the VCS 160. Any updates or improvements to the serialization/deserialization logic are committed to the central serializer/deserializer repository 156 though the VCS 160, although other embodiments encompass the serializer/deseriazlier repository 156 being separate from the VCS 160 and rather managed through an asset developer application.

Asset developers 100 are able to pull the latest version of the library from the serializer/deserializer repository 156, ensuring that everyone uses the most up-to-date serialization/deserialization logic. As such, the logic of the serializer/deserializer 140 is shared among asset developer workstations 300 by being part of a centrally maintained library stored in serializer/deserializer repository 156, which be accessed via the VCS 160. Asset developers 100 import this library into their projects, ensuring they all use consistent serialization/deserialization methods. Any updates to the logic are committed to the central serializer/deserializer repository 156, and asset developers 100 synchronize their local environments by pulling the latest changes.

The version control system 160 manages the versioning and tracking of all serialized assets 150. The version control system 160 ensures that each version of a serialized asset 150 is properly stored and can be retrieved as needed. The version control system 160 tracks all changes, manages dependencies, and supports collaborative development. The version control system 160 is responsible manages the versioning, tracking, and storage of FMware assets. The version control system 160 ensures that each version of a serialized asset 150 is properly stored, metadata is maintained, and dependencies are tracked. The version control system 160 integrates with both stored serialized assets 180 and external storage 190 to handle various types of assets.

The stored serialized assets 180 may refer to the storage location within the version control system 160 where serialized versions of smaller or medium-sized assets are kept. Stored serialized assets 180 are stored in a structured, version-controlled storage system within the version control system 160. This storage may utilize solid-state drives (SSDs) and/or hard disk drives (HDDs) on the version control system server 310 (see FIG. 2) hosting the version control system 160, optimized for quick retrieval and efficient versioning of small to medium-sized serialized assets 150, such as configuration files, source code, prompts, agents and documentation. The stored serialized assets 180 ensures data integrity, supports metadata management, and facilitates dependency tracking between assets.

The stored serialized assets 180 may store metadata including version information providing details about the version of the asset, such as version number, commit hash, and timestamps. The metadata may include storage location such as a URL or path information indicating where the asset is stored in the external storage 190. The metadata may include dependency information ensuring all related components are correctly linked and versioned. The metadata may include a unique hash, such as SHA-1 or SHA-256, generated for each asset version, ensuring data integrity and enabling efficient retrieval. The stored serialized assets 180 may store the assets themselves depending on size. The stored serialized assets 180 may include configuration files including serialized configurations, including hyperparameters and experiment settings. The stored serialized assets 180 may include serialized versions of scripts and code files. The stored serialized assets 180 may include prompts providing serialized prompts used for interacting with models, which may include static text, dynamic templates, and associated metadata.

The external storage 190 is used for storing large binary files and extensive datasets that are too large to be efficiently stored within the stored serialized assets 180 of the version control system 160 itself. When storing the serialized assets 150 in external storage 190, associated metadata is stored in stored serialized assets 180. The metadata may include the storage location such as URL or path information indicating where the asset is stored in the external storage 190. The metadata may include version information including version number, commit hash, and timestamps. The metadata may include dependency information ensuring all related components are correctly linked and versioned. The metadata may include a unique hash generated for the metadata, ensuring data integrity and linking the metadata to the actual asset in external storage 190.

The serialized assets 150 stored in external storage 190 may include model files such as large binaries of pre-trained and fine-tuned models. The serialized assets 150 in external storage 190 may include large datasets used for training and evaluation.

The version control system 160 is configured to receive a serialized asset 150 from a developer workstation 300. When a developer commits a new version, the asset is serialized using the custom logic defined in the developer workstation 300. The version control system 160 generates metadata including version information, author details, change logs, and dependency data. The metadata includes a unique hash for the serialized asset 150. The hash is generated based on relevant data that needs to be hashed, including the serialized asset, metadata such as version number, author information, timestamps, and dependency information. The version control system 160 utilizes a cryptographic hash function (e.g., SHA-1, SHA-256) to the collected data. This function processes the input data and produces a unique, fixed-size hash value. The output hash is a unique identifier for the specific version of the asset. It is stored along with the metadata in the version control system.

The version control system 160 determines whether the asset should be stored in stored serialized assets 180 or external storage 190 based on the asset's size and type. Small and medium sized assets may be stored directly in stored serialized assets 180. Large assets such as binary files are stored in the external storage 190, with accompanying metadata stored in stored serialized assets 180.

The version control system 160 implements a fetch process when a fetch request is received from an asset developer 100. The version control system 160 retrieves the metadata, including the hash, from the stored serialized assets 180. The hash is used to verify the integrity of the retrieved data. Small and medium assets may be retrieved directly from the stored serialized assets 180 using the metadata. For large assets, metadata from stored serialized assets 180 is used to locate and retrieve the actual asset from external storage 190.

The version control system 160 passes the latest version of the serialized asset 152 to the serializer/deserializer 140 for deserializing using the custom logic defined in the developer's workstation 300, reconstructing the asset for use by the asset developer 100.

Continuing to refer to FIG. 1, versioning information 170 is used for tracking and managing different versions of an asset. The versioning information 170 may be provided by the asset developer 100 as part of a fetch request 164 (see FIG. 2) and is used when retrieving assets from stored serialized assets 180 or the metadata associated with external storage 190. The version control system 160 uses the versioning information 170 to locate the metadata for the requested asset version within stored serialized assets 180. This metadata includes the version number and a unique hash. The hash is used to verify the integrity of the serialized asset. The version control system 160 computes the hash of the retrieved asset and associated metadata and compares it with the stored hash to ensure that the asset has not been tampered with. Once the integrity is verified, the serialized asset 150 is deserialized using the custom deserialization logic included in the sterilizer/deserializer 140 and as defined by the asset developer 100. This process reconstructs the asset in its original format, making it ready for use. For retrieval of assets from external storage 190, the metadata is retrieved from stored serialized assets 180, which includes the storage location (URL or path) in external storage 190, version number and a unique hash. Using the version control system 160, the asset is retrieved from the storage location in external storage 190 provided in the metadata. This may involve downloading a large binary file or dataset. The hash included in the metadata is used to verify the integrity of the asset retrieved from external storage 190. The version control stem 160 computes the hash of the downloaded asset and compares it with the stored hash to ensure its integrity.

FIG. 1 illustrates a commit process 200, which involves saving new versions of serialized assets into the stored serialized assets 180 or the external storage 190 as described above. The fetch process 210 involves retrieving the latest or a specific version of an asset from the stored serialized assets 180 or from the external storage 190.

FIG. 2 further illustrates the asset management system 2000 of FIG. 1 in accordance with exemplary embodiments described herein. The asset management system 2000 described in FIG. 2 includes the developer workstation 300, the serializer/deserializer 140, a version control system server 310, the stored serialized assets 180, and the external storage 190. These components interact to support asset management through processes such as serialization, deserialization, committing new versions, and fetching specific versions.

The developer workstation 300 stores local asset copies 110, which are the versions of the assets that asset developers 100 work on locally. The assets include one or more of model files, configuration files, source code, documentation, agents and prompts. The prompts may be serialized prompts used for interacting with models, which may include static text, dynamic templates, and associated metadata. The agents may be software entities that can autonomously perform tasks based on predefined instructions or inputs, often using AI models.

The developer workstation 300 can be any of a variety of computing devices, such as a laptop, desktop, or other personal computing device. The developer workstation 300 includes, in various embodiments, a processor, which may be in the form of a central processing unit (CPU) that executes computer-readable instructions to perform the functions described herein, such as modifying local asset copies, generating commit requests, and processing fetch requests. The developer workstation 300 includes memory such volatile memory (RAM) for temporary storage of data during execution and non-volatile memory (e.g., SSDs or HDDs) for persistent storage of local asset copies 110. The developer workstation 300 includes computer programming instructions stored in memory and executed by the processor. The instructions, when executed, may perform tasks such as serialization, deserialization, version management, and communication with the version control system server 310. The developer workstation 300 may include a display device to allow the asset developer 100 to interact with the system, display asset versions for fetch requests, and output information to support asset modification. The display device may include a monitor, touchscreen, or other visual display. The developer workstation 300 may include input devices such as a keyboard touchscreen and/or mouse for inputting commands and modifying assets. The developer workstation 300 may include a communications interface to facilitate sending and receiving data to and from the version control system server 310 and the serializer/deserializer repository 156. This may include network adapters, Wi-Fi modules, or other networking hardware.

The developer workstation 300 may produce a commit request 162, which is a request generated by the developer workstation 300 to commit a new version 120 of an asset to the version control system server 310. The developer workstation 300 may output new version data 120 representing the new version 120 of the asset, ready to be serialized and committed. The developer workstation 300 may output a fetch request 164 to fetch a specific version of an asset from the version control system server 310, such as the latest version 152.

The developer workstation 300 may include a local copy of the serializer/deserializer 140. The serializer/deserializer 140 may output serialized asset data 150, which is a serialized version of the asset that has been serialized and is ready for storage via processes of the version control system server 310. The serialzier/deserializer 140 may output deserialized asset data 155, which is data representing a fetched version of a serialized asset (e.g. the latest version of the asset) that has been retrieved by the version control system server 310 and deserialized for use by the developer workstation 300 for modification.

The serializer/deserializer repository 156 is a repository that contains the logic for serializing and deserializing assets, accessible to a plurality of developer workstations 300 and the version control system server 310.

The version control system server 310 may be a server machine or a cluster of servers designed to handle high volumes of data and many requests. The version control system server 310 includes a processor such as a CPU or multiple CPUs that execute computer-readable instructions for managing version control operations, handling commit and fetch requests, maintaining metadata and other functions as described herein. The version control system server 310 includes memory comprising volatile memory (RAM) for fast access to data and non-volatile memory (e.g., SSDs or HDDs) for long-term storage of version control data and metadata. Computer programming instructions manage, when executed by the processor, the version control operations, including versioning information 170, metadata 172, and communication with the developer workstation 300 and external storage 190, amongst other operations described herein. The version control system server 310 includes network interfaces for communicating with the developer workstation(s) 300 and external storage 190. This may include Ethernet ports, Wi-Fi modules, or other networking hardware. The version control system server 310 includes stored serialized assets 180 housed in a structured, version-controlled storage system for efficient retrieval and storage of serialized assets. The stored serialized assets 180 may be embodied by non-volatile memory devices such as SSDs or HDDs for storing serialized versions of small to medium-sized assets and metadata 172. The stored serialized assets 180 are typically organized in a database or file system optimized for version control.

The version control system server 310 includes an asset management interface 142 through which developers, specifically the developer workstation 300, interact with the version control system server 310. The asset management interface 142 manages communications between the developer workstation 300 and the version control system server 310, particularly of fetch and committed serialized assets.

The version control manager 144 manages the versioning and tracking of all serialized assets 150. When a commit request 162 is received from the developer workstation 300, the version control manager 144 processes this request. Each new version of an asset, in the form of new version data 120, is assigned a unique identifier, often a hash, to distinguish it from previous versions. This identifier is part of the versioning information 170. The version control manager 144 works with the metadata manager 146 to maintain metadata 172 for each asset. This metadata includes version numbers, author information, timestamps, and dependency information. The version control manager 144 manages the dependencies between different assets, ensuring that related components are properly versioned together and can be accurately retrieved when needed. The version control manager 144 manages the storage of serialized assets 150: For small to medium-sized assets, the serialized asset data 150 is stored directly within the structured storage represented by the stored serialized assets 180. For larger assets, such as big model files and datasets, the version control manager 144 coordinates with the external storage interface 330 to store the serialized asset data 150 externally. The corresponding metadata, including storage location and integrity hash, is kept within the stored serialized assets 180 if the version control system 10.

When a fetch request 164 is received, the version control manager 144 locates the requested asset version using the versioning information 170. When an asset developer 100 commits changes, the version control system server 310 provides a commit log, which includes a version tag. This log may be accessed by the developer workstation. Asset developers 100 may use tags or version numbers to mark specific versions of an asset. These tags may be stored by the version control system 160 and can be referenced during a fetch request 164. The version control system server 310 provides an interface (e.g., through the asset management interface 142) where asset developers 100 can remotely browse and search for specific versions of assets, obtaining the necessary version tags.

To ensure data integrity, the version control manager 144 verifies the hash of the retrieved asset data against the stored hash value retrieved from the stored serialized assets 180. The version control manager 144 supports branching, allowing asset developers 100 to create separate branches for different lines of development. Each branch maintains its own set of versions and can be managed independently. When changes from different branches need to be integrated, the version control manager 144 manages the merging process, resolving conflicts and consolidating versions as necessary. In some embodiments, the developer workstation 300 is notified when a commit request conflicts with a version of the asset that has previously or concurrently been committed.

The version control manager 144 manages the commit process. When an asset developer 100 modifies a local asset copy 110 on the developer workstation 300 and initiates a commit request 162, the version control manager 144 receives the commit request 162 and the serializer/deserializer 140 serializes the new version data 120 into serialized asset data 150. The serialized asset data 150, along with its versioning information 170 and metadata 172, is stored either in the stored serialized assets 180 and/or external storage 190.

The version control manager 144 receives the fetch request 164 issued by the developer workstation 300 to retrieve a specific version of an asset. The fetch request 164 includes a version tag, which may be provided from memory of the developer workstations 300 or may be selected through a user interface of the developer workstation 300 that accesses versioning information 170 provided by the version control system server 310. The version control manager 144 locates the version using versioning information 170 that is mapped to the version tag provided by the developer workstation 300 and retrieves the associated metadata 172 including a hash. The version control system server 310 generates a hash based on the retrieved asset and the metadata and verifies the integrity of the asset using the retrieved hash. Once verified, the asset is deserialized by the developer workstation 300 using the serializer/deserializer 140.

The external storage interface 330 manages interactions with external storage 190, particularly by providing storable serialized asset data 166 that is to be stored in the external storage.

The external storage 190 is used for storing large binary files and extensive datasets that exceed the capacity of typical version-controlled storage systems. The external storage 190 may include storage hardware in the form of high-capacity non-volatile memory devices such as enterprise-grade SSDs, HDDs, or network-attached storage (NAS) systems. These devices provide the necessary capacity and performance for large asset storage.

The storable serialized asset data 166 is data that is ready to be stored in the stored serialized assets 180 of version control system 160 or the external storage 190.

The commit handler 148 processes commit requests 162, stores serialized asset data by interacting with the external storage 190, and updates versioning information 170 through interacting with the version control manager 144.

The fetch handler 152 processes fetch requests 164, retrieves metadata 172 through interaction with the metadata manager 146 and retrieves the assets through interaction with the version control manager 144.

The metadata manager 146 manages the metadata 172 associated with each asset version. The metadata manager 146 is responsible for the comprehensive management of metadata 172 associated with each asset version. This includes the creation, storage, retrieval, and maintenance of detailed metadata 172 for every versioned asset. The metadata 172 may encompass version numbers, author information, timestamps, dependency information, and/or hash values. Upon receiving a commit request 162 by the version control manager 144, the metadata manager 146 generates and assigns unique version identifiers, such as commit hashes, and maintains a mapping between developer-friendly version tags and these specific versioning details. It also records dependencies between assets, ensuring that all related components can be accurately versioned and retrieved together. Additionally, the metadata manager 146 stores hash values to allow the version control manager 144 to verify the integrity of assets during retrieval by comparing stored hashes with computed hashes of the retrieved data.

Continuing to refer to FIG. 2, an example workflow will be described. An asset developer 100 may initialize an asset on their workstation 300. The asset, such as a model file, prompt or agent, is stored as a local asset copy 110. The asset developer 100 may make changes to the local asset copy 110 and decide to commit a new version. A commit request 162 is generated, and the new version data 120 is prepared. The new version data 120 is serialized into serialized asset data 150 using the serializer logic stored in the serializer/deserializer repository 156. The commit handler 148 processes the commit request 162 and in association with the version control manager 142, stores the serialized asset data 150 in stored serialized assets 180 or external storage 190, and updates the versioning information 170. Metadata 172, including the hash, is generated and managed by the metadata manager 146. The asset developer 100 may instigate a fetch request 164. Assuming, the asset developer 100 may need to retrieve a specific version of the asset and generates a fetch request 164 including a version tag. The fetch handler 152 processes the fetch request 164 and in association with the version control manager 144, retrieves the metadata 172 corresponding to the version tag and the associated serialized from stored serialized assets 180 and/or external storage 190, generates the has and verifies the hash included in the metadata 172 to ensure data integrity. The retrieved serialized asset data 150 is deserialized into deserialized asset data 155 using the deserialization logic stored in the serializer/deserializer repository 156.

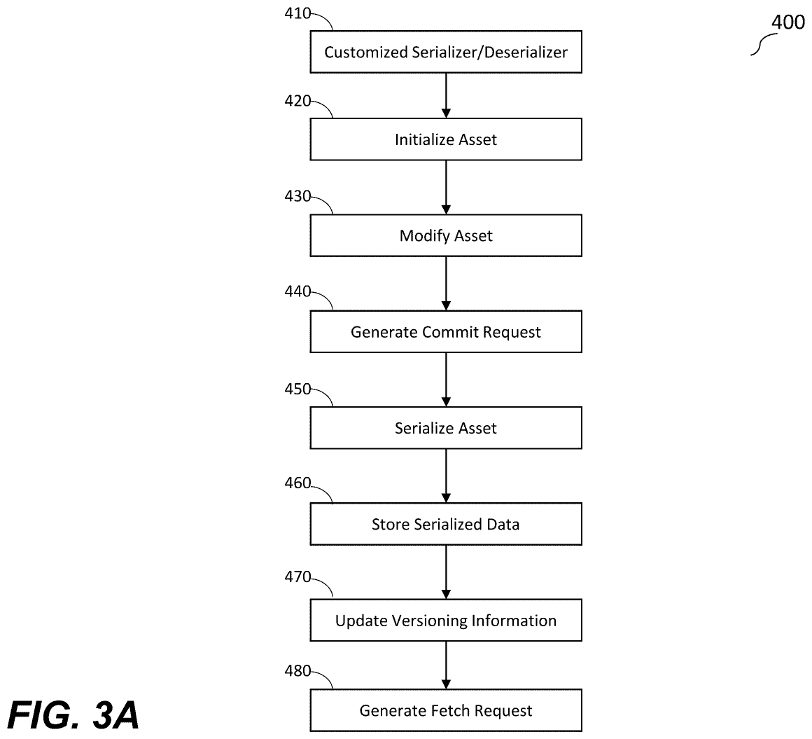

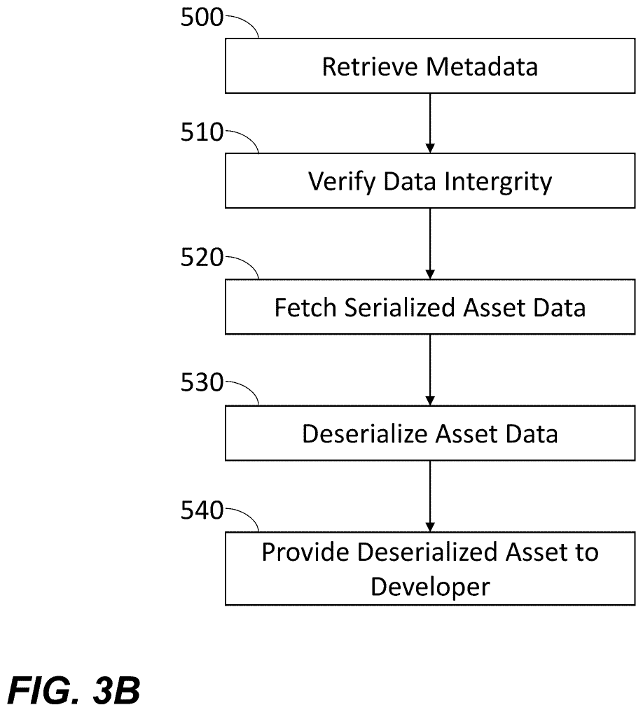

In FIGS. 3A and 3B, an exemplary computer implemented method 400 for managing assets is illustrated. FIGS. 3A and 3B are described with reference to the asset management system 2000 of FIGS. 1 and 2. The method 400 of FIGS. 3A and 3B is implemented on the developer workstation 300 and by a processor thereof executing computer readable instructions. The method 400 includes various calls to hardware external to the developer workstation 300 including the version control system server 310 and data is transferred between them over a wireless network. It should be understood that the order of the steps is provided by way of example and is not limiting.

In step 410, the logic of the serializer/deserializer 140 is customized by an asset developer 100. The asset developer 100 specifies custom serialization and deserialization logic for the asset within the serializer/deserializer repository 156. Asset developers 100 can specify the implementation logic of the serializer/deserializer 140, which may be unique to each of the assets being managed. As such, different serialization/deserialization logic is defined for each asset type to accommodate unique structures, formats, metadata requirements, storage needs, dependency management, and performance considerations of each asset. Different types of asset include models (e.g. large binary files), datasets (e.g. CSV, JSON, or binary), configuration files (e.g. text files in formats like JSON, YAML, or XML), prompts (e.g. static text, templates, or dynamic scripts) and agents (e.g. including code, configuration, and state information).

In step 420, the asset developer 100 working on the developer workstation 300 creates and initializes a new asset instance, such as a model file or developer prompt. The asset is stored as a local asset copy 110 on the developer workstation. In one embodiment, an asset class is imported from the asset management module 142. An instance of the asset class is created and initialized with an asset name and the asset data (e.g. model data). This instance represents the asset to be managed.

In step 430, the asset developer 100 modifies the local asset copy 110, making desired changes to the asset instance. In the case of a model instance, the asset developer 100 may perform parameter tuning (e.g. by adjusting hyperparameters), modifying the neural network architecture such as adding or removing layers, changing activation functions or altering layer dimensions, updating training data and/or fine tuning. In the case of developer prompts, the text or templates of the prompt may be modified, changing the formatting of the prompt, adding or otherwise changing examples and/or modifying any embedded logic. In the case of an agent instance, the instructions or rules governing the agent may be changes and modifying the code defining functionality of the agent may be changed.

In step 440, a commit request 162 is generated. After modifying the asset, the developer 100 generates a commit request 162 on the developer workstation 300. This commit request signifies the intention to save the new version 120 of the asset to the version control system server 310.

In step 450, the new version 120 of the asset is serialized. The commit request 162 triggers the serializer/deserializer 140 to serialize the new version data 120. This involves converting the modified asset file into a serialized format suitable for storage. The serialized asset data 150 is a predefined structured data representation (e.g. a serialized model dictionary) and includes metadata such as the asset's name, storage URL, timestamp, version number, and dependencies.

In step 460, the serialized asset data 150, along with its metadata 172, is sent to the version control system server 310. The version control system server 310 processes the commit request 162 by storing the serialized asset data 150 in the appropriate storage location. For small to medium-sized assets, the data is stored in stored serialized assets 180. For large assets, the data is stored in external storage 190, with metadata 172 capturing the storage location and hash for data integrity verification being stored in the stored serialized assets 180.

In step 470, a unique version identifier (e.g., commit hash) for the new asset version is created. This information is recorded in the metadata 172 as part of updating the versioning information.

In step 480, a fetch request 164 is generated. The asset developer 100 may wish to retrieve a specific version of the asset file. The asset developer 100 generates a fetch request 164 on the developer workstation 300, specifying the asset name and the version tag by selection from a list or by retrieving the information from local storage.

In step 500, the fetch request 164 is sent to the version control system server 310, which uses the asset name and version tag to locate the relevant metadata 172. The version control system server 310 retrieves the versioning information 170 and associated metadata 172 for the specified version. This metadata includes the hash value and storage location of the asset.

In step 510, the retrieved asset file is verified. The version control manager 144 verifies the integrity of the retrieved asset by comparing the stored hash with the computed hash of the retrieved asset data. This ensures that the asset has not been altered or corrupted.

In step 520, the version control system server fetches the serialized asset data 150. Based on the metadata 172, the version control system server 310 retrieves the serialized asset data 150 from either stored serialized assets 180 or external storage 190. The data is then sent to the serializer/deserializer 140 for processing.

In step 530, the serializer/deserializer 140 deserializes the retrieved serialized asset data 150 into deserialized asset data 155. This involves converting the serialized format back into the original asset file format.

In step 540, the developer workstation 300 receives the deserialized asset data 155. The deserialized asset data 155 is sent back to the developer workstation 300, where the asset developer 100 can use the specific version of the model file as needed.

In embodiments, the serializer/deserializer 140 can be replaced by any function or program that serializes an asset for a format that is understood by the version control system 160 and then use the services offered by the version control system 160. For example, an external program can be written to serialize an asset into a text-based format and then use a version control system as Git to version control the asset (or its metadata). In this case, the external program deals with low level functions provided by the version control system server 310.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

1. A computer implemented method of managing an asset for machine learning, the method comprising:
retrieving, from a version control system server over a network, an asset for machine learning;
deserializing the asset from a serialized asset data format to a deserialized asset data format using a seriazlier/deserializer to generate a deserialized asset;
modifying, via at least one processor of an asset developer workstation, the deserialized asset to generate a new version of the asset;
serializing the new version of the asset using the serializer/deserializer to generate a serialized new asset; and
sending, from the asset developer workstation, the serialized new asset to the version control system server over the network for storage.

2. The computer implemented method of claim 1, wherein the serializer/deserializer is stored in a central repository accessible by a plurality of asset developer workstations.

3. The computer implemented method of claim 1, wherein the asset comprises at least one of: machine learning models, datasets, configuration files, source code, prompts, and software agents.

4. The computer implemented method of claim 1, comprising, via the at least one processor of the developer workstation, a commit request to the version control system to initiate storing of the serialized new asset, the commit request including: serialized asset data corresponding to the serialized new asset and at least one of: asset name, asset version number, metadata comprising model name, storage location and/or timestamp, dependencies, and hash value for verification.

5. The computer implemented method of claim 1, comprising generating, via the at least one processor of the developer workstation, a hash value using a cryptographic hash function based on the new version of the asset and sending, from the asset developer workstation, the serialized new asset and the hash value to the version control system server over the network for storage.

6. The computer implemented method of claim 1, wherein the deserialized asset data and serialized asset data corresponding to the serialized new asset comprises:
for a machine learning model, binary deserialized asset data representing the weights and architecture of the machine learning model and serialized asset data in the form of JSON string or binary blob;
for datasets, CSV, Parquet, or database tables deserialized asset data and JSON string or binary blob for serialized asset data;
for configuration files, the deserialized asset data includes text files and the serialized asset data includes JSON string representing the configuration parameters;
for prompts, the deserialized asset data includes text files or strings containing prompts and the serialized asset data includes JSON string containing prompt text and related metadata; and
for software agents, the deserialized asset data includes executable code or scripts and the serialized asset data includes JSON string or binary blob.

7. The computer implemented method of claim 1, comprising initializing, via the at least one processor of the asset developer workstation, an asset by creating an asset class and populating the asset class with asset data retrieved external storage over the network.

8. The computer implemented method of claim 1, comprising sending a fetch request, via the at least one processor and from the developer workstation, the fetch request including the asset name and version tag; retrieving, from the version control system server over the network, an asset corresponding to the fetch request, wherein the asset is in serialized data format; and deserializing the asset using the serializer/deserializer for modification on the developer workstation.

9. The computer implemented method of claim 8, wherein the version control system retrieves serialized asset data based on the asset name and the version tag and associated metadata including a hash vale and wherein the version control system generates a reference hash value based on the serialized asset data, the version control system comparing the hash value and the reference hash value to verify that a correct version of the serialized asset data has been retrieved before sending to the asset developer workstation over the network.

10. The computer implemented method of claim 1, wherein an asset developer of the developer workstation defines, through a user interface, custom serialization and deserialization logic for each of a plurality of asset types, the serialization and deserialization logic used by the serializer/deserializer, the serialization and deserialization logic including instructions for converting the asset between serialized and deserialized data formats, wherein the serialization and deserialization logic differs based on asset type.

11. The computer implemented method of claim 1, comprising storing the custom serialization and deserialization logic in a repository accessible to a plurality of developer workstations.

12. The computer implemented method of claim 1, comprising determining a storage location of the serialized new asset based on asset size, wherein the storage location includes local storage of the version control system and external cloud storage.

13. An asset developer computer for managing an asset for machine learning, comprising:
at least one processor;
local storage comprising a non-transitory computer-readable medium storing instructions that, when executed by the at least one processor, are configured to:
retrieve, from a version control system server over a network, an asset for machine learning;
deserialize the asset from a serialized asset data format to a deserialized asset data format using a seriazlier/deserializer to generate a deserialized asset;
modify the deserialized asset to generate a new version of the asset;
serialize the new version of the asset using the serializer/deserializer to generate a serialized new asset; and
send the serialized new asset to the version control system server over the network for storage.

14. The asset developer computer of claim 13, wherein the asset comprises at least one of: machine learning models, datasets, configuration files, source code, prompts, and software agents.

15. The asset developer computer of claim 13, wherein the instructions, when executed by the at least one processor, are configured to send a commit request to the version control system to initiate storing of the serialized new asset, the commit request including: serialized asset data corresponding to the serialized new asset and at least one of: asset name, asset version number, metadata comprising model name, storage location and/or timestamp, dependencies, and hash value for verification.

16. The asset developer computer of claim 13, wherein the instructions, when executed by the at least one processor, are configured to: generate a hash value using a cryptographic hash function based on the new version of the asset and send the serialized new asset and the hash value to the version control system server over the network for storage.

17. The asset developer computer of claim 13 wherein the instructions, when executed by the at least one processor, are configured to: send a fetch request, the fetch request including an asset name and a version tag, retrieve, from the version control system server over the network, an asset corresponding to the fetch request, wherein the asset is in serialized data format, and deserialize the asset using the serializer/deserializer for modification on the developer workstation.

18. The asset developer computer of claim 13, wherein an asset developer operating the asset developer computer defines, through a user interface, custom serialization and deserialization logic for each of a plurality of asset types, the serialization and deserialization logic used by the serializer/deserializer, the serialization and deserialization logic including instructions for converting the asset between a serialized and deserialized data format, wherein the serialization and deserialization logic differs based on asset type.

19. The asset developer computer of claim 13, wherein the deserialized asset is stored on the local memory.

20. A computer readable medium storing instructions that, when executed by at least one processor are configured to perform a method for managing an asset for machine learning, the method comprising:
retrieving, from a version control system server over a network, an asset for machine learning;
deserializing the asset from a serialized asset data format to a deserialized asset data format using a seriazlier/deserializer to generate a deserialized asset;
modifying, via at least one processor of an asset developer workstation, the deserialized asset to generate a new version of the asset;
serializing the new version of the asset using the serializer/deserializer to generate a serialized new asset; and
sending, from the asset developer workstation, the serialized new asset to the version control system server over the network for storage.
